(19) United States
(12) Patent Application Publication
(10) Pub. No.: US 2019/0255771 A1
(43) Pub. Date: Aug. 22, 2019

(54) APPARATUS AND COMPUTATIONAL MODELING FOR NON-PLANAR 3D PRINTING

(71) Applicant: University of Connecticut, Farmington, CT (US)

(72) Inventors: Horea Ilies, Glastonbury, CT (US); Radu Ioan Corcodel, Storrs, CT (US)

(21) Appl. No.: 16/280,445

(22) Filed: Feb. 20, 2019

Related U.S. Application Data
(60) Provisional application No. 62/632,657, filed on Feb. 20, 2018.

(51) Int. Cl. B29C 64/209; B29C 64/118; B29C 64/245; B29C 64/241; B29C 64/236

(52) U.S. Cl. CPC B29C 64/209; B29C 64/118; B33Y 10/00; B29C 64/241; B29C 64/236; B29C 64/245

(57) ABSTRACT

A method of depositing a material with an extrusion tip of an additive manufacturing machine includes translating the extrusion tip relative to a build platform and rotating the extrusion tip about an axis of the extrusion tip relative to the build platform.

### CROSS-REFERENCE TO RELATED APPLICATIONS

This application is a non-provisional of and claims the benefit of U.S. Provisional Application No. 62/632,657, filed on Feb. 20, 2018, the contents of which are incorporated herein by reference.

### STATEMENT REGARDING FEDERALLY SPONSORED RESEARCH OR DEVELOPMENT

This invention was made with government support under grant numbers CMMI-1462759, IIS-1526249, and CMMI-1635103, awarded by the National Science Foundation. The government has certain rights in the invention.

### BACKGROUND

One of the most widely used 3D printing techniques, namely the two-and-a-half-axis fused deposition modeling (FDM), relies on depositing thermoplastic materials in a layer-by-layer fashion, while the machine executes a planar translation in each planar layer. As a result, the as-manufactured model is approximated with planar cross-sections perpendicular to a given, fixed direction. Slicing is the process of producing the planar cross-sections and determines the build accuracy of the as-manufactured model based on the dimensional tolerance along the slicing direction. Because the layers have a finite thickness, the overall height of the build can only be a multiple of the layer thickness.

For any planar layered 3D printing technique, the dimensional accuracy upper bound along the build direction of a 2.5-axis apparatus, referred to as z-axis, is half the layer thickness. Choosing this Z-axis is a prerequisite of the manufacturing process because it has a great impact on the build quality, such as surface roughness and aspect, as well as the mechanical rigidity of the manufactured part and its accuracy. Commercial slicing software uses an automated Z-axis selection algorithm which relies on computing the minimum support volume needed to for the build. Other characteristics that are accounted for when choosing a build direction include maximizing the surface area between the first layer and the printing bed, minimizing the dimensional tolerance between the as-manufactured model and the nominal one, and the projected build time. The contact surface between the first layer and the bed may be less relevant if rafts are used. Rafting refers to extending the footprint of the first layer, primarily to improve adhesion with the bed. This technique may be used with amorphous materials (such as Acrylonitrile Butadiene Styrene—ABS) which have no true melting point. FIG. 1 shows parts that are constructed with rafts. A poorly chosen Z-axis may require unreasonable support structures or “support” (FIG. 2), or may result in very thin cross-sectional areas which cannot be resolved by the printer/extruder combination. Thinning the cross-sections may not improve the dimensional accuracy in ant process involving the melting of the material due to excessive local heating or insufficient cooling. Additionally, the width of a path is dictated by the diameter of the circular nozzle, thus a cross-section smaller than the nozzle's aperture cannot be resolved.

### SUMMARY

The present invention relates to additive manufacturing involving material that being deposited on a planar layer, on a non-planar surface or directly in 3D.

In some embodiments, an additive manufacturing machine includes an extrusion tip having a non-circular geometry.

In another embodiment, the invention provides a method of determining a maximum build volume for an extruder nozzle geometry of a 3D printer. The method includes determining a set of configurations s(u), parametrized by a vector “u” of length “p”, wherein p is the number of degrees of freedom of the 3D printer, determining the desired target geometry, G, calculating the motion inverse configuration for all parameter vectors “u” that the 3D printer is capable of executing, and calculating if the inverse configuration intersects the geometry of a minimum printable feature.

In yet another embodiment, the invention provides an additive manufacturing machine. The additive manufacturing machine includes an extrusion tip operable to expel a material, a build platform defining a build volume onto which the material is printed, and a support arm mounted to the extrusion tip and configured to direct the extrusion tip in a normal direction to any three-dimensional curve within the build volume.

In yet another embodiment, the invention provides a method of preparing motion synthesis for a target geometry with a 3D printer having an extruder. The method includes determining a set of configurations parametrized by a vector of length P, wherein P is the number of degrees of freedom of the 3D printer, determining a plurality of machine parameters for which the nozzle geometry is contained in the interior of a target geometry G, calculating a parametric set [symbol] and a parametric set [symbol] corresponding to a plurality of extruder configurations in which the extruder is touching the point p and is interior to the target geometry G, calculating a normal, tangent, and binormal direction and the radial distance r corresponding to the point p, and calculating the angles between all candidate semi-major axes and the local normal direction at the point p.

In yet another embodiment, the invention provides a method of depositing a material with an extrusion tip of an additive manufacturing machine. The method includes translating the extrusion tip relative to a build platform, and rotating the extrusion tip about an axis of the extrusion tip relative to the build platform.

In yet another embodiment, the invention provides an additive manufacturing machine. The additive manufacturing machine includes a build platform and an extrusion tip having an aperture through which a material is operably expelled to the build platform. The aperture defines an axis. The extrusion tip is configured to translate relative to the build platform. The extrusion tip is configured to rotate relative to the build platform about the axis.

Other aspects of the invention will become apparent by consideration of the detailed description and accompanying drawings.

### BRIEF DESCRIPTION OF THE DRAWINGS

FIG. 1 shows a complete and unsupported build exhibiting large overhangs in unsupported regions.

FIG. 2 shows an incomplete part of a supported build.

FIG. 3 illustrates a knee prosthesis.

FIG. 4A shows an as-manufactured geometry using a planar toolpath.

FIG. 4B shows the toolpath along the target surface using planar slices.

FIG. 4C shows an as-manufactured geometry using a spatial toolpath.

FIG. 4D shows the toolpath along the target surface using the spatial toolpaths.

FIG. 5A illustrates a circular extruder in planar motion.

FIG. 5B illustrates an elliptical extruder in planar motion.

FIG. 6 illustrates the straight medial axis of a U-shaped planar polygon.

FIG. 7 is a flow chart showing an active loop of a motion synthesis algorithm for planar layers and elliptical extruders.

FIG. 8 is a flow chart showing the complete motion synthesis algorithm for planar layers and elliptical extruders.

FIG. 9A illustrates an elliptical extruder in motion in a first area.

FIG. 9B illustrates an elliptical extruder in motion in a second area.

FIG. 9C illustrates an elliptical extruder in motion in a third area.

FIG. 9D illustrates a sparse overlay of instantaneous extruder poses.

FIG. 10 shows an extruder sweep over the target geometry including instances where the extruder is partially outside the target.

FIG. 11 shows an extruder sweep over the target geometry in which the extruder only sweeps over the boundary of the target.

FIG. 12 shows all parameters for which the extruder only deposits material inside the target geometry.

FIG. 13 shows a single pass of the elliptical extruder in which the extruder is maintained normal to the target boundary where possible.

FIG. 14 shows a second pass after the first pass of FIG. 13.

FIG. 15 shows two passes promoting a higher accuracy by using the medial axis.

FIG. 16 illustrates the expected output of 3D motion synthesis at a single point.

FIG. 17 illustrates the expected output of 3D motion synthesis at a plurality of points along a path.

FIG. 18A illustrates a solid fill of a target contour with a circular extruder.

FIG. 18B illustrates a solid fill of a target contour with an elliptical extruder.

FIG. 18C shows a corresponding set of configurations where the circular nozzle of FIG. 18A is contained within the contour.

FIG. 18D shows a corresponding set of configurations where the elliptical nozzle of FIG. 18B is contained within the contour.

FIG. 19A shows the inverse trajectory of a random point as it intersects point y.

FIG. 19B shows the inverse trajectory of another random point as it intersects point y.

FIG. 19C shows the inverse trajectory of yet another random point as it intersects point y.

FIG. 19D shows a scenario in Euclidean space where there are no points which pass through the point y during forward motion.

FIG. 20A shows the inverse trajectories of sample point yⱼ ∈ G and the respective intersection set with the circular nozzle A⁰ in its initial configuration.

FIG. 20B shows the inverse trajectories of sample point xᵢ ∈ ∝G and the respective intersection set with the circular nozzle A⁰ in its initial configuration.

FIG. 20C shows the set of parameters for which the nozzle is completely contained within the target contour.

FIG. 21 shows a sweep of a nozzle within a parameter range, showing the under-fill areas created by enforcing the MMC tolerance condition.

FIG. 22A shows a puzzle shape filled using a circular extruder.

FIG. 22B shows the puzzle shape filled using an elliptical extruder.

FIG. 22C shows the parametric domain corresponding to the circular extruder.

FIG. 22D shows the parametric domain corresponding to the circular extruder.

FIG. 22E shows the parametric domain corresponding to the elliptical extruder.

FIG. 22F shows the parametric domain corresponding to the elliptical extruder.

FIG. 23A illustrates the advantages of a rotational elliptical extruder.

FIG. 23B shows the parameter selection corresponding to the set [symbol] .

FIG. 23C shows the selection [symbol] and [symbol] .

FIG. 24A shows a target contour containing many small features.

FIG. 24B shows the parameter selections which ensures that the circular nozzle stays inside the target contour of FIG. 24A.

FIG. 25A shows a target contour containing many small features.

FIG. 25B shows the parameter selections which ensures that the rotational elliptical nozzle stays inside the target contour of FIG. 25A.

FIG. 26A shows a nominal geometry to be printed.

FIG. 26B shows a model to be built using a circular print head on a Cartesian 3D printer.

FIG. 26C shows a model to be built using a non-rotational elliptical print head on the Cartesian 3D printer.

FIG. 26D shows a model to be built using a rotational elliptical print head on the Cartesian 3D printer.

FIG. 26E shows a section of the computed volumetric build of FIG. 26B.

FIG. 26F shows a section of the computed volumetric build of FIG. 26C.

FIG. 26G shows a section of the computed volumetric build of FIG. 26D.

FIG. 27A shows a kinematic configuration of a robot arm.

FIG. 27B shows a robot arm.

FIG. 28A illustrates the nominal geometry of a dental implant.

FIG. 28B illustrates the achievable geometry with a circular extruder.

FIG. 28C illustrates the achievable geometry with an elliptical extruder.

FIG. 28D shows the additional volume added by the elliptical extruder of FIG. 28C in comparison to the circular extruder of FIG. 28B

FIG. 29A illustrates a superimposed as-manufactured geometry of a molar built with a circular extruder and an elliptical extruder, both extruders having smaller diameters than those used in FIGS. 28B-C.

FIG. 29B shows a cross-section of the as-manufactured geometries corresponding to those of FIGS. 28B-C.

FIG. 29C illustrates the added volume deposited by the elliptical extruder compared to that of the circular extruder.

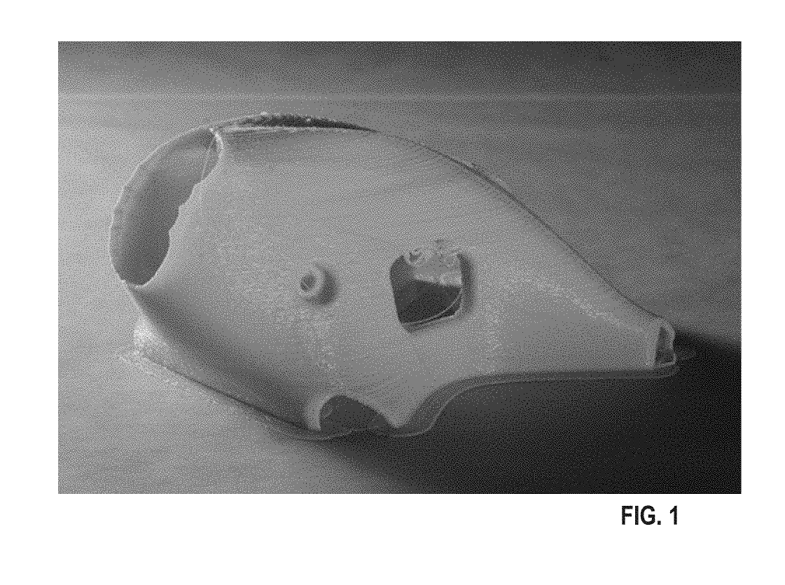

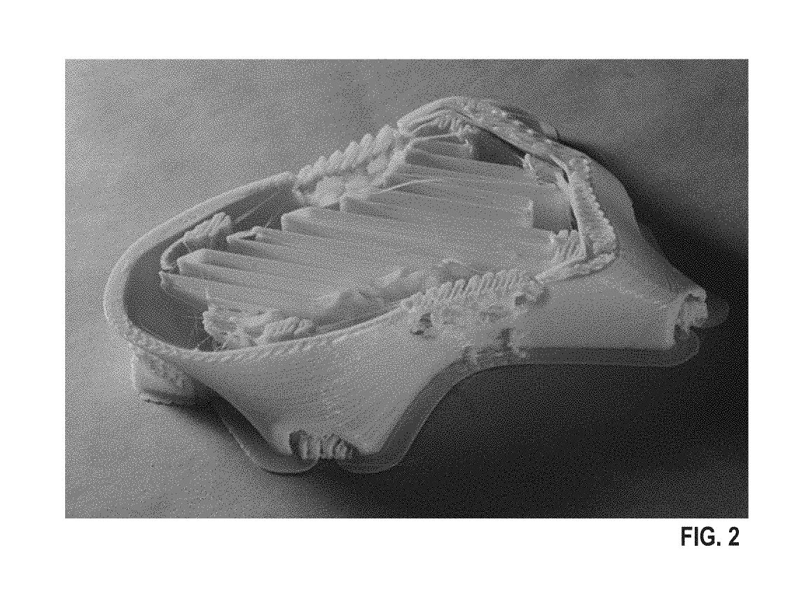

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

An emerging Additive Manufacturing technique employs the use of a multi-DOF mechanical structure, typically a 5-axis CNC machine, intended to give the extruder one or more degrees of freedom. An advantage of having a tilting print head comes from the 2.5-axis machines' inability to track three-dimensional surfaces. The mechanism of generating 3D objects using planar layers affects the build accuracy since slicing can only occur along some given direction, which favors the part's XY-plane. The reasoning behind this is that along the X and the Y axis, the resolution of the build is given by a combination of the machine's precision, the dimensions of the hot-end, the filament flow rate and the material used. On the other hand, along the Z-axis, the staircase artifact dominates all other process characteristics. In addition, many 2.5-axis configurations include the printing bed actuating on the Z-axis making room for positioning error and more important, vibrations during high-dynamics motions. In general, regardless of machine configuration, users avoid placing the Z-axis along critical dimensions or other functional characteristics of the build.

A multi-DOF architecture, such as a robotic arm or a multi-axis CNC machine would thus be able to not only pan the print head in a local coordinate system, but also adjust the orientation of the nozzle with respect to the part's surface normal. As a first goal, this Additive Manufacturing technique describes a consistent and unambiguous method of positioning the nozzle of the hot-end relative to an arbitrary 3D surface.

The example in FIG. 3 shows a practical situation when a fully spatial tool-path would improve dramatically the volumetric deviation between the nominal and the as-manufactured geometry. The example shows the polymer insert used in a knee replacement prosthesis for reconstructive surgery. Components for prostheses have been traditionally manufactured in low volume production cycles such as silicone casting or investment casting. The disadvantage of using these technologies is that it is a two-step process in which a component (a positive) is manufactured first, usually from resin or wax, after which the cast can be created. A more cost-effective method involving rapid prototyping has been recently used to manufacture parts for prosthetic applications but this method primarily uses Selective Laser Sintering or Vat Photopolymerization. Aside from cost, some of the biggest advantages for using additive manufacturing in these applications is the shorter lead time, while at the same time allowing a more particularized design of the 3D model as well as a high accuracy fitment.

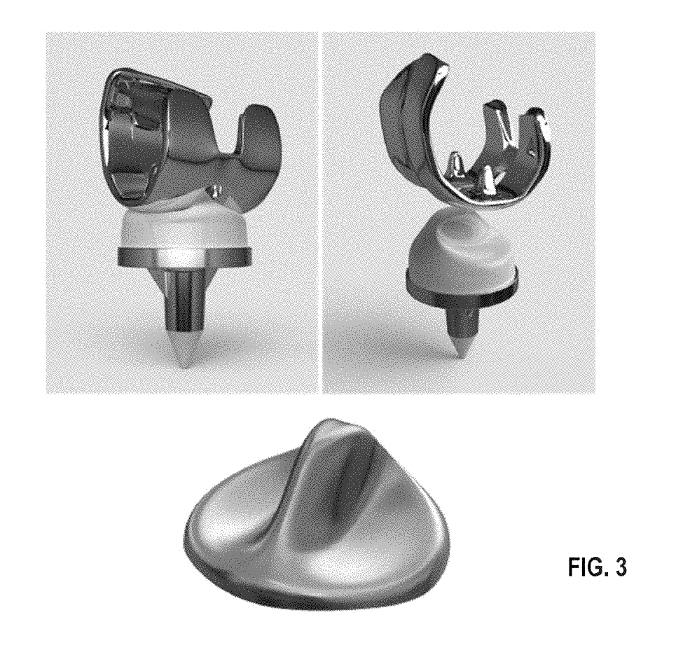

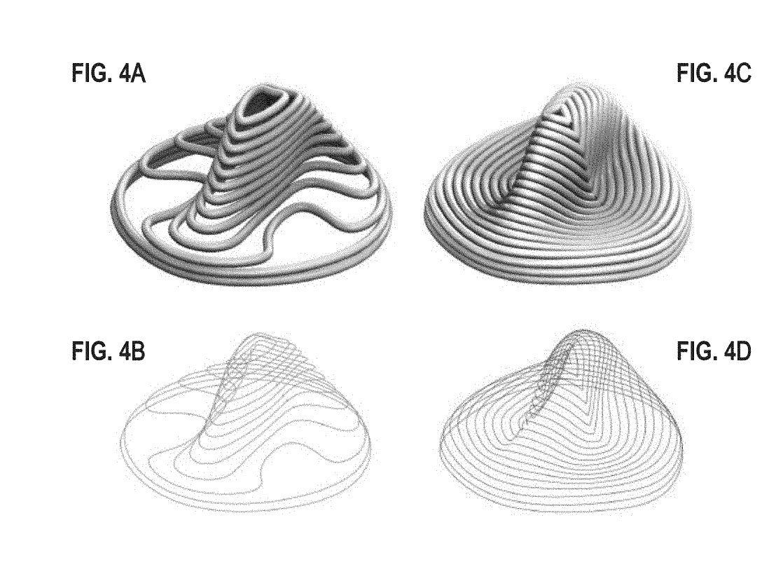

Any layered printing technique exhibits a staircase effect, which comes from the need to slice the 3D model into layers. Fusion Deposition Modeling (FDM), to this date, is not a preferred technology for high accuracy builds mainly because of this technique's familiar staircase effect. FDM is one of the most affordable Additive Manufacturing techniques, while at the same time delivers good mechanical properties of the manufactured model, making it very suitable for low volume production runs or unique builds. In an attempt to visually demonstrate the main disadvantage of using layered 3D printing techniques in applications involving free-form surfaces, FIGS. 4A-4D show a simulated as-manufactured volume of the active component in the replacement knee shown in FIG. 3. The model shown in FIGS. 4A-4B is constructed using planar slices, of large thickness to emphasize the stair-case effect. In this example the extruder used to build the model is having a circular aperture, of similar size with the layer thickness, and can only move in an XY-plane. In practice, the surface artifact is more pronounced when the layer thickness approaches the radius of the circular extruder, while a layer “higher” than the extruder's radius will lead to a lack of inter-layer fusion. One observation is that even if the layer height is small enough, the deposited material will continue to exhibit an interruption in the fused volume. The reason for this unwanted behavior is that the free-form boundary presents many regions where the surface local normal deviates slightly from the build direction. In this case, neighboring paths of the extruder correspond to layers of different height leading to a sparse sampling of the surface boundary. In the best case, a sparse sampling of the surface would lead to a pronounced staircase effect, but as FIG. 4A shows, in a more typical scenario this would lead to a lack of fusion between the swept traces. For reference, FIG. 4B shows the 2D trajectories of the extruder's center. Another important observation is that the planar slices will approximate the model with a higher accuracy when the surface normal is closer to perpendicular relative to the build direction. This is one of the metrics that commercial slicing algorithms are using for determining the optimal build direction. And finally, since the slicing direction does not change during build and the layer thickness remains constant, the model height remains the higher dimensional error of the build, because the as-manufactured model's dimension on the Z-axis can only be an integer multiple of the layer height.

The simulated model in FIG. 4C was constructed using spatial trajectories and a circular extruder nozzle having the same size as in FIG. 4A. In this construction, the extruder is allowed at least two extra rotational degrees of freedom about two non-collinear axes (for example attached to a 5-axis milling center or a 6DOF robot arm). This requirement will ensure that the nozzle's axis of symmetry can be positioned along the local surface normal. A possible solution for generating spatial trajectories of a three-dimensional free-form surface is to begin with a planar slice and then gradually construct curve offsets based on the geodesic distance from the seeding curve. This assumption makes sense because the build starts from the surface of the print bed. The print bed may be a planar print bed defined by a planar build surface, or may otherwise be a non-planar print bed defined by a non-planar or free-form build surface. In order to have a meaningful comparison, the offset distance was maintained to the same value as the layer thickness from FIG. 4A. As expected there are no major differences between planar and non-planar layers in the first two trajectory loops, because the planar layers approximate correctly surfaces that have their normal close to perpendicular to the build direction. As the build progresses, the figure shows evenly fused traces, regardless of surface normal. This is because the geodesic-based offset implicitly guarantees fusion in neighboring traces, regardless of trajectory complexity. An added advantage of using spatial trajectories is that the printing bed can be a free-form surface as well. Finally, FIG. 4D shows the loop trajectories of the extruder's center, obtained from surface offset curves.

If the Rapid Prototyping machine used to create the model in FIG. 4C is a “table-tilt” configuration, an additional advantage (at no cost) is that all newly deposited traces are implicitly supported by either the print bed (first layer), or the previously deposited layers, because the extruder's axis of symmetry is aligned with the “vertical” direction (i.e. acting along g, the direction of gravity). This implies that hollow build are possible using spatial trajectories for theoretically arbitrarily complex target geometries.

Since extruders with circular apertures are rotation invariant about their center axis, the corresponding volume deposited can be more easily calculated with Minkowski operations. The Additive Manufacturing applications where the extruder is allowed to move relative to a three-dimensional surface is a recasting of the 5-axis milling process, where the set mathematical operator is converted from subtraction to addition. Even though this approach would apply to additive manufacturing with fully three-dimensional tool path, it is not generic since its core formulation relies on classic morphological operations such as the Minkowski sum and difference. The CNC motion generation is point based for most, if not all, current 5-axis manufacturing processes, and involves a motion interpolation between discrete points on the target surface. Point interpolation is a process where the tool center moves between two consecutive target points using some arbitrarily defined approximation of the nominal surface. One of the most popular choices in point interpolation uses Non-Uniform Rational B-Splines (NURBS) computed on-the-y using Field Programmable Gates Arrays (FPGA). This approach takes advantage of the tool's axial symmetry to generate a curve-like trajectory of the tool tip. In the case of additive manufacturing, the “tool” tip is the center of the circular extruder. The shape similarity between a bull-nose end-mill and the instantaneous extrusion droplet (more commonly referred to as smallest printable feature) bridges the two manufacturing concepts (additive versus subtractive) and enables fully three-dimensional trajectory computations. For extruders with non-circular apertures, the process similarity between classic 5-axis machining and rapid prototyping is lost. Non-circular apertures imply that the smallest printable feature is not symmetric about its center point, and thus not rotation invariant. Motion planning in this case cannot rely on the classic morphological operations because spatial tool paths generally include a three dimensional rotation about a point.

The solution space for path planning in both fixed and evolving domains is unbounded, reason for which an infinite set of motions can be generated to cover an arbitrarily given three-dimensional surface. Coverage path planning (CPP) includes: complete coverage of the target domain, fixed or moving obstacle avoidance (if present), non-repetitious trajectories, and controlled overlap between adjacent paths.

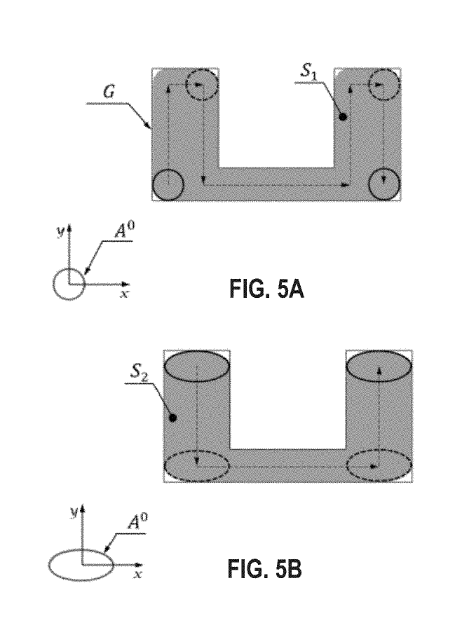

The last condition in this attribute list is important to motion planning in Additive Manufacturing, particularly in FDM because the fused volume between neighboring traces dictates not only the structural and mechanical properties of the build but also the dimensional precision of the as manufactured part. Generally speaking, there are infinite many trajectories that can be synthesized based on the attribute list presented above. Reason for which one of the simplest motion strategies, implemented initially in cleaning robots, is a randomized path generator which puts the robot on a collision-free trajectory with the environment. In this approach the assumption is that if the robot spends enough time covering randomly a non-evolving domain, it will eventually cover it. The obvious disadvantage of this approach is that the paths are, in the most general case, self-intersecting. In terms of FDM, real time measurements (such as vision, close range LIDAR or echo-location) could potentially correct the self-intersection issue along with generating a controlled overlap of the fused material, but the trajectory would become impractical because the print head will have to execute non-extruding motions while avoiding already extruded traces. In collaborative Additive Manufacturing, (i.e., extrusion with multiple extruders, possibly uncoupled by the same printing head) this randomized method would become completely unpractical. To correctly assess the corresponding properties of the spatial motion of print heads equipped with circular and non-circular extruders, FIGS. 5A-5B show a planar contour which is covered by a known circular extruder (FIG. 5A) and respectively an elliptical extruder in FIG. 5B.

A possible trajectory of the extruder's center can be seen in FIGS. 5A-5B marked with dotted lines. In order for the extruder to cover the target area in as few interpolations as possible, the asymmetric extruder maintains its semi-major axis perpendicular to the bounding contour. This comes as a natural remark since in this orientation, the extruder aperture will sweep the maximum possible surface in one pass. In the narrower passages on the other hand, the extruder changes its orientation relative to the contour's normal to ensure that the width of the trace does not exceed the target boundary. This implies an exception from the first condition which enforces the semi-major axis to be aligned with the local normal to the contour. Therefore the motion property can be rephrased as: the asymmetric extruder maintains the smallest available angle, α, between the semi-major axis and the local boundary normal. Mathematically, this exception can be formalized as a minimization problem. A generic methodology for computing the set [symbol] of all possible print head configurations for which the extruder's nozzle, and thus the smallest printable feature, is guaranteed interior to a target volume is calculated, as described above. This set of configurations represents the search domain of this minimization routine, which is a restriction of the parametric domain [symbol] . To alleviate computations, this restriction can be further simplified via set operations. Given a sample point x ∈ ∂G on the target boundary for which the corresponding angle α is computed, one can determine the set of configurations [symbol] ∈ [symbol] using the inverse motion, where

[symbol]

={ [symbol] ∈ [symbol] |I( [symbol] ,x)=1}

The indicator function I is given by I: [symbol] ×E^{d}→{0,1}. Given a point x ∈ E^{d} and a motion parameter vector [symbol] ∈ [symbol] is defined as:

$$I ( x , 𝓊 ) = \{ \begin{matrix}1 , & if {A}^{0} ⋂ {x}^{r ( u )} \neq ∅ \\ 0 , & otherwise\end{matrix}$$

In this notation, the element r(u)∈ \hat{M} is the inverse transformation corresponding to the parameter vector [symbol] ∈ [symbol] , while A⁰ is the initial configuration of the smallest printable feature.

From the property of the inverse trajectory, the set [symbol] represents all configurations for which the extruder deposits material over the boundary sample point x ∈ ∂G. As a result, the set intersection [symbol] = [symbol] ∩ cl( [symbol] ) corresponds to those configurations for which the smallest printable feature is both interior to the target volume G, as well “touches” the sample point x. In the previous equation, the closure operator cl(.) is required because [symbol] ∩ [symbol] =Ø. As previously discussed, the set [symbol] is given by [symbol] ={u ∈ [symbol] |I(u, x)=1, ∀x ∈ iG, thus defined over the open set iG. Since the inverse trajectory partitions the Euclidean space in a non-ambiguous classification, there is no set intersection between the sets [symbol] and [symbol] .

In the associated implementation of this methodology, computing the set [symbol] reduced the number of candidate configurations from 8e⁶ to a few hundred for each boundary sample. It is fair to assume that the extruder is rigidly attached to the print head and its major/minor axes are aligned with the local coordinate system. Therefore, this minimization problem can be described as the smallest angle computed between the local boundary normal and the axis of the print head's mobile coordinate system, transformed according to the parameter vectors [symbol] ∈ [symbol] , or mathematically defined as α=min arc cos(\hat{N}ₓ·Ox^{s(u)}), where u ∈ [symbol] . The reachability condition is intrinsically built-in this formulation, since unreachable interior points of the target geometry G will not have any corresponding configurations in the restricted parametric set [symbol] .

The angle α corresponds to the print head configuration for which the extruder will sweep the largest local area of the target geometry, without exceeding its boundary. In the case of narrow passages, if they are reachable, the extruder could cover the entire area in one pass. To improve motion fluidity and limit the number and complexity of non-printing interpolations, the motion attributes should contain a secondary characteristic acting as a relaxation condition to the minimizing function presented above. This second motion attribute can be phrased as: the generated motion should contain the smallest number of inactive point interpolations. The disadvantages of non-printing, or inactive, interpolations can be observed primarily in the surface quality. During repositioning, the extruder retracts the filament from its aperture to prevent unwanted deposition, while at the destination it primes the nozzle yet again. In practice, these non-active sequences, trigger modifiers on the filament flow control command M108-S/P, by using the prime and retract directives M227 and M228. Because the viscous-elastic properties of the filament can range not only with the material, but also from spool to spool, these modifiers should be avoided because they can impact the quality and precision of the as-manufactured part. In this formulation, this motion attribute can be formulated using a signed distance field from the boundary. A geometric descriptor that falls into this category is the medial axis.

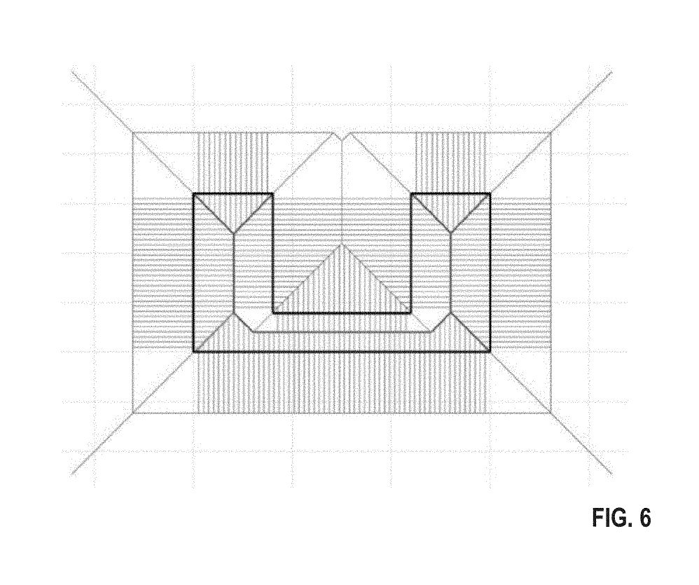

FIG. 6 shows both the internal and external medial axis (MA) of a planar polygon. By definition, the MA transform encodes the distance from two boundary points, equidistant to some point on the internal MA. FIG. 6 also shows, in green, the perpendicular distance from sample points on the boundary to the MA. This lower dimensional skeleton is defined for arbitrary planar geometry and even for three-dimensional surfaces, making it suitable for a generic formulation of spatial motion planning. The MA is not only a geometric construction; each point y on the MA has assigned a radial function r(y) that encodes the signed distance to the generator's boundary. For this reason, the MA can be used as a geometric representation of solid geometry because the generator can be constructed by taking the union of all disks centered on the MA and having the radius equal to the radial function corresponding to that medial point. Computationally, the time complexity is 0(n log n), and presents some instability with generators obtained from noisy data. In this application, the MA is used primarily for computing the trajectory of elliptical-aperture extruders in planar motion, after which the same concept will be applied to spatial motions and layer-less printing.

The perpendicular distance from a boundary sample point to the MA, can be seen as a measure of fitness (or weight) for the angle α, since the medial axis effectively encodes the local “width” of the target geometry. More specifically the radial distance encoded by the MA can be compared to the dimensions of the elliptical extruder in order to determine if the motion can be synthesized without any filament flow interruption (i.e., no idle interpolations).

Given an extruder with an elliptical aperture parametrized by semi-major axis a and semi-minor axis b, the sub-unitary weight w defined over all points x ∈ ∂G is given by:

$$w ( x ) = \{ \begin{matrix}1 , & if r ( x ) > 2 b \\ \frac{r ( x ) - 2 b}{2 ( a - b )} , & if 2 b \leq r ( x ) \leq 2 a \\ 1 , & otherwise\end{matrix}$$

The weight doubles as a selector function. When the radial function value corresponding to some sample x ∈ ∂G lays between the semi-major and semi-minor “diameters” of the ellipse, it means that the extruder can potentially cover the geometry in two passes, both tangent to the MA. An observation to the formulation of w(x) is that when the radial function is below the semi-minor diameter, the weight's effect is discarded (i.e., set to 1). Two situations correspond to this case: the boundary point is unreachable by the elliptical extruder, or the boundary point is close to a discrete vertex of the target boundary so the medial axis comes into contact with the contour (see FIG. 6). In both cases the weight becomes irrelevant because if the point is unreachable, then the search algorithm will find no intersection set (i.e., [symbol] ∩ [symbol] =Ø) while a point close to the vertex will be handled by the approximation of the local normal. Using this weight, the required angle α_{w} between the ellipse's semi-major axis and the local boundary normal is simply given by:

α_{w}=min[ [symbol] arc cos(Nₓ·Ox^{s(u)})]

As a pre-computation, the algorithm for calculating the planar motion of an elliptical extruder requires the following: discretization of the target boundary, building an oriented list of boundary samples, constructing the MA and its radial function, and computing the parameter restriction [symbol] .

These prerequisites are invariant for any given target geometry and for each machine configuration. From an implementation standpoint, the geometry sampling and the motion parameter sampling are decoupled to enable accelerated computing. The accompanying code developed for this algorithm uses homogeneous transformation matrices, so that the forward and inverse motions are represented as two finite sets of transformations. These transformations are derived from the forward and inverse kinematics of the machine structures under analysis, and the parametric space [symbol] is represented as a p-dimensional binary image. The sample point list is ordered using a classic K-Nearest Neighbor (KNN) search using an open source geometry kernel (CGAL rev. 4.9.1) while the internal medial axis is constructed as a straight skeleton using the “exact predicates and inexact construction kernel” algorithm. This ensures that the geometric kernel can compute the MA for arbitrary planar contours given by a CCW ordered list of vertexes. Finally, cl( [symbol] ) is calculated using dilation, a classic image processing technique, which expands the [symbol] binary image by one “pixel” on all parametric axes.

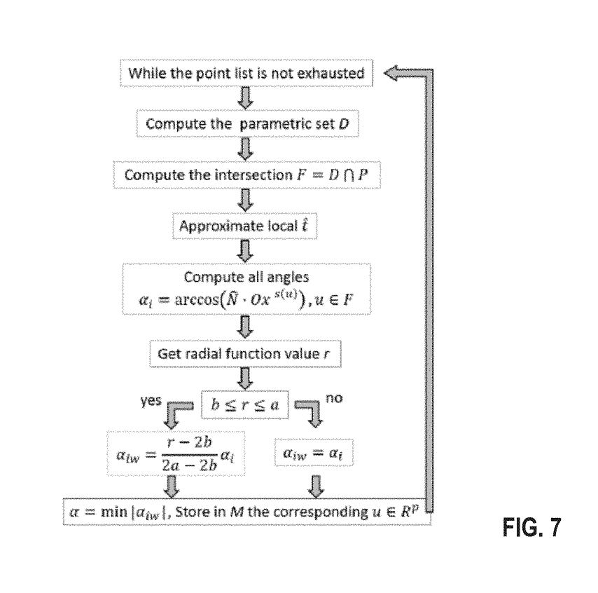

The block diagram in FIG. 7 shows the active loop of the motion planning algorithm in the case of planar layers and elliptical extruders. The core of this loop consists of computing the parametric set [symbol] , followed by performing the set intersection [symbol] ∩ cl( [symbol] ). This part of the loop may be GPU accelerated for a faster running time. The angle computation can theoretically be achieved by taking the arc cosine of the dot product. Although correct, this method produces numerical instability and is also not quadrant sensitive. To ensure a more generic solution for the angle computation, the accompanying implementation uses both the cross and the dot product of the two vectors and the angle is computed with a tan 2(.):

αᵢ=a tan 2(∥\hat{N}ₓ×Ox^{s(u)}∥, \hat{N}ₓ×Ox^{8(u)})

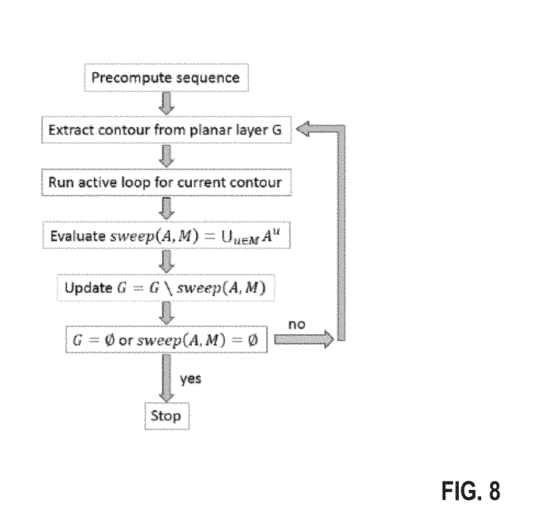

The local normal computation can be replaced with local tangent and offset the minimizer by π/2. This is particularly advantageous with large datasets because the tangent approximation is already prerequisite of the normal evaluation. The algorithm for generating the complete motion for an arbitrary planar contour printed with an elliptical extruder is presented in FIG. 8.

At the end of the main loop, the conditional ensures that the loop will terminate. The first condition, naturally, states that if all contours have been covered by the elliptical extruder, the algorithm should terminate. The second condition is needed because of the pseudo-offset paths that are generated by the motion planner. Since the last contour to be generated might contain only unreachable points, the parameter set M=Ø; and therefore sweep (A, M)=Ø; This will cause that the Euclidean set G to not change geometry and thus create an infinite loop.

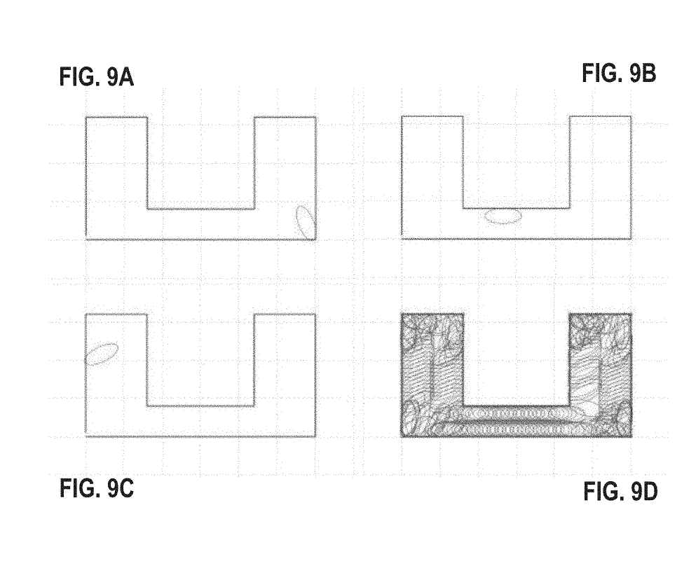

FIGS. 9A-D show an example of motion synthesis performed for a benchmarking planar U-shape. The dimension of the narrow passage at the bottom of the shape is equal to the semi-minor diameter, set on purpose to test the edge case. The motion behavior at the corners is also controlled by a “look-behind” algorithm which keeps a log of the previous print head orientations. This also allows the print head to execute more fluid motions without switching configurations abruptly in a short amount of time. The synthesized motion will execute eight interpolations for this shape without interrupting the material flow, and thus fulfilling one of the more important motion attributes, despite being forced to lengthen the build time. In FIG. 9D, an overlay of sparsely selected extruder poses is shown to visualize full trajectory of the print head, as well as examining the fused volume for neighboring passes.

The maximum build volume is determined with three inputs. The first input is the nozzle aperture geometry. In an infinitesimal amount of time, the nozzle will deposit a droplet of material called with minimum printable feature, labeled “A”. The second input is the 3D printer head motion and is described by a set of configurations s(u), parametrized by a vector “u” of length “p”, where p is the number of degrees of freedom of the printer. The third input is the desired target geometry, labeled “G”.

Given these inputs, the expected outputs include all machine parameters “u” for which the nozzle geometry is contained in the interior of the target geometry “G”. Once all feasible “u”s are known, the maximum geometry that the nozzle will sweep can be calculated. The maximum computed geometry can then be compared to the target geometry to calculate the build accuracy.

To achieve the desired outputs, the motion inverse configuration r(u)=[s(u)]⁻¹ is calculated for all possible parameter vectors “u” that the 3D printer is capable of executing (i.e., within the limits capable by the 3D printer). The nozzle aperture is homed to the zeroth configuration. This pose of the minimum printable feature is labeled with A⁰. An indicator function I is defined as follows:

$${ℝ}^{p} \times {𝔼}^{d} -> \{ 0 , 1 \} with I ( x , u ) = \{ \begin{matrix}1 , & if {A}^{0} ⋂ {x}^{r ( u )} \neq ∅ \\ 0 , & otherwise\end{matrix} .$$

This function signals or indicates if some query point “x”, as transformed by a given inverse configuration “r(u)”, intersects the geometry of the minimum printable feature in its homed position. In other words, since “u” is given, the function indicates if the point “x” will be visited by the extruder nozzle when the 3D printer's axes are at values u=[u₁ u₂ u₃ u₄ . . . ].

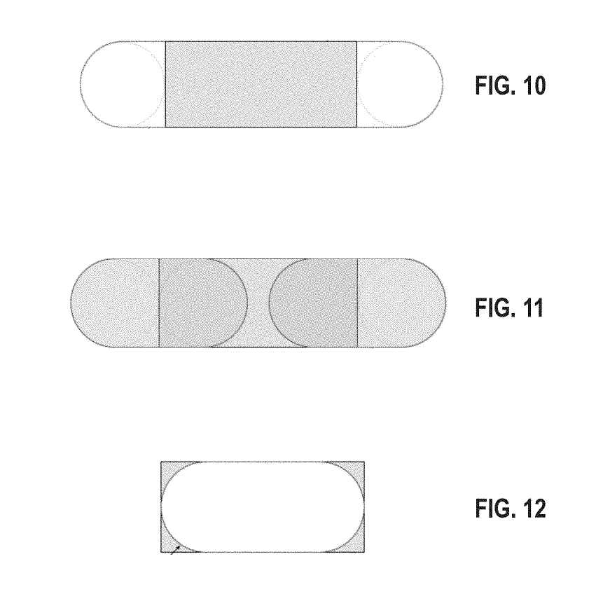

In addition to calculating the 3D printer's inverse configurations r(u), the set [symbol] ={u ∈ [symbol] : I(u, x)=1, ∀x ∈ G} is calculated. This set identifies all parameters “u” at which the extruder sweeps over the target geometry, including those parameters where the extruder is partially outside the target. FIG. 10 illustrates a representative path for the nozzle head. The target geometry is the shaded rectangle. The 3D printer only translates horizontally. FIG. 10 shows that there are parameters where the extruder is partially outside the target. At the limit, the extruder is completely outside the target and barely touches the boundary of the target geometry.

The set [symbol] ={u ∈ [symbol] : I(u, x)=1, ∀x ∈ ∂G} is also calculated. This set identifies the parameters “u” at which the extruder only sweeps over the boundary of the target. As shown in FIG. 11, the parameters u from the set D, are those unwanted values of “u” from the set “B”. Subtracting the set D from the set B ( [symbol] = [symbol] \D) produces the set [symbol] that contains all parameters “u” for which the extruder only deposits material inside the target geometry G, as shown in FIG. 12. The maximum build volume can be calculated as a sweep defined as:

S=Sweep(A, P)=∪_{u∈P} A^{s(u)}

Further, the accuracy of the maximum build volume can be calculated as a Lebesgue measure:

k=λ(G\S)

Motion synthesis with an FDM 3D printer using discrete two-dimensional planar layers with an elliptical extruder nozzle requires three inputs. The first input is the target geometry “G”. The second input is the 3D printer head motion described by a set of configurations s(u), parametrized by a vector “u” of length “p”, where p is the number of degrees of freedom of the printer. The third input is all machine parameters “u” for which the nozzle geometry is contained in the interior of the target geometry “G,” as described above. Further to the three inputs described above, the system has the ability to calculate the principal directions for a set of points (i.e., tangent, normal, binormal) and the ability to calculate the medial axis of a set of points and the corresponding radial function.

The motion follows a policy as described below. Firstly, the elliptical extruder has its semi-major axis perpendicular to the target boundary to promote the fastest manufacturing time. Secondly, the elliptical extruder does not exceed the boundary of the target geometry (i.e., it is always contained within the interior of the target). Thirdly, the as-manufactured volume is as close as possible to the maximum build volume. With the manufactured volume denoted with “Q”, and the maximum build volume denoted with “S”, the volume is defined with the following relationship: Q ⊆ S ⊆ G. Based on these policies, at least one sequence of parameters “u” is expected as an output.

As shown in FIG. 13, based on the first two points of the motion policy, the extruder is maintained normal to the target boundary, unless it exceeds the boundary. In such a case, the extruder is rotated about its center axis to the closest angle to normal, without exceeding the boundary. Without the third motion policy, a second pass would result in the undesirable path shown in FIG. 14 in which the geometry is not fully realized. Instead, as shown in FIG. 15, based on the third point of the motion policy, the extruder is further rotated about its center axis to allow a second pass, thereby promoting a higher accuracy of the as-manufactured volume.

A single contour is calculated as follows, and as shown in FIG. 7. The parametric set [symbol] ={u ∈ [symbol] : I(u, p)=1, p ∈ ∂G} and the intersection F=P′ ∩ D (where P′ is the set P dilated by an infinitesimal amount in all directions of the underlying parametric space) are computed. Set F corresponds to the extruder configurations which are both touching the point “p” and are interior to the target geometry “G”. The principal directions (normal, tangent, binormal) at point “p” are computed. The medial axis is also computed for the entire boundary to calculate the radial distance corresponding to point “p”. This radial distance is denoted by “r”. The directions of the semi-major axis are computed for all candidate extruder configurations according to A^{s(u)}, u ∈ F. Further, the angles αᵢ between all candidate semi-major axes and the local normal direction are computed at “p”. If b≤r≤a, where b is the semi-minor radius and a is the semi-major radius of the ellipse, a correction is applied to the computed angles:

$${α}_{iw} = \frac{r - 2 b}{2 a - 2 b} {α}_{i}$$

The minimum α_{iw} is located and the corresponding parameter “u” is stored in a set u ∈ M.

A solid 2D target is calculated as follows, and as shown in FIG. 8. The boundary ∂G is extracted from target G. An active loops is run and the parameters u ∈ M are retrieved. The swept set S=∪_{u∈M} A^{s(u)} is computed, the set corresponding to the current boundary ∂G. The target geometry is updated by subtracting the already swept set: G=G\S. If “S” is not empty and the updated “G” is not empty, the process is repeated. By utilizing the condition that “S” should not be empty, the system ensures that the algorithm terminates when the remaining target is smaller in size than the dimensions of the extruder. FIGS. 9A-D illustrate an example of the expected output of the calculated path.

Motion synthesis with an FDM 3D printer using three-dimensional non-planar layers with an elliptical extruder nozzle requires three inputs. First, the target geometry G is a 3D surface. Second, the 3D printer head motion is described by a set of configurations s(u), parameterized by a vector “u” of length “p”, where p is number of degrees of freedom the printer has available. Third, all machine parameters “u” for which the nozzle geometry is contained in the interior of the target geometry “G”, as described above.

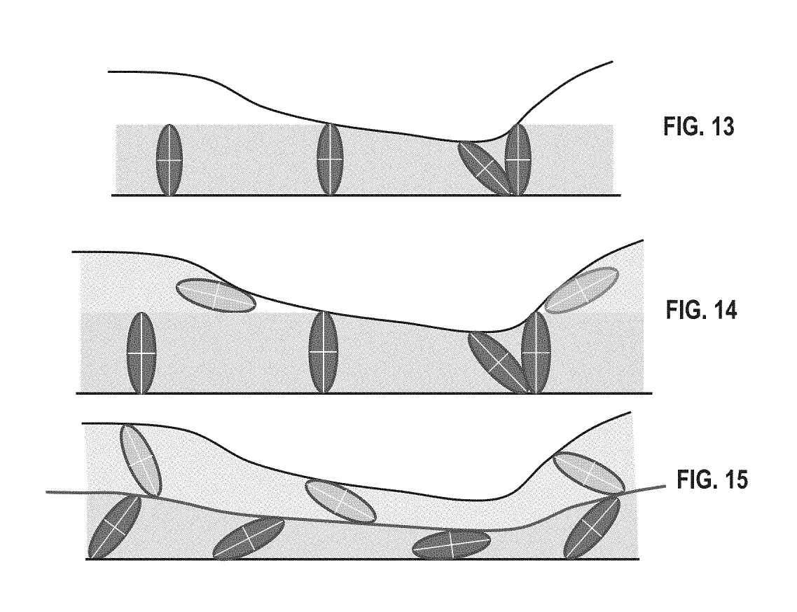

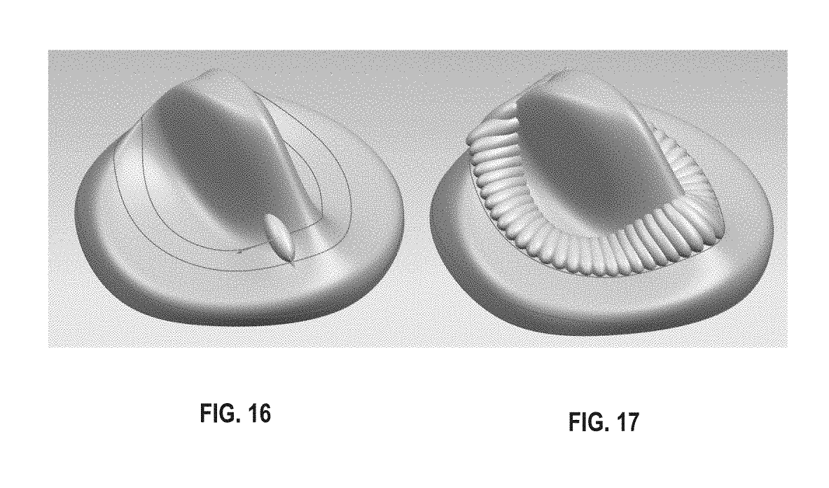

The motion follows a policy as described below. First, the elliptical extruder has its semi-major axis perpendicular to offset curves (on the target surface). The offset is taken based on the geodesic distance. Second, the semi-minor axis of the elliptical extruder is parallel to the local tangent vector of the offset curve. Third, to complete the triad, the binomial vector of the ellipsoid is normal to the target surface. The expected output is illustrated in FIGS. 16-17. FIG. 16 illustrates a single point based on the elliptical tip of the extruder head. FIG. 17 illustrates a plurality of discrete points chosen to illustrate the smooth three-dimensional path achieved by the three-dimensional motion synthesis.

The three-dimensional non-planar layer is mapped by seeding from the boundary of the 3D surface (curve), constructing geodesic offset curves with an offset d=a where “a” is the dimension of the semi-major axis of the elliptical extruder. On each curve, and for each point “p” on the curve, the local normal to offset curve n_{c} is calculated. Further, the local normal to surface nₛ is calculated. The corresponding parameters u ∈ R are located for which the extruder is aligned with the two vectors n_{c} and nₛ (i.e., the center axis of the extruder is aligned with vector nₛ and the semi-major axis is aligned with vector n_{c}) and the center of the extruder is at location “p”. The as-manufactured volume is calculated as a sweep given by:

$$Q = Sweep ( A , R ) = {⋃}_{u ∈ R} {A}^{s ( u )}$$

The accuracy of the as-manufactured volume is calculated as a Lebesgue measure

k=λ(G\Q)

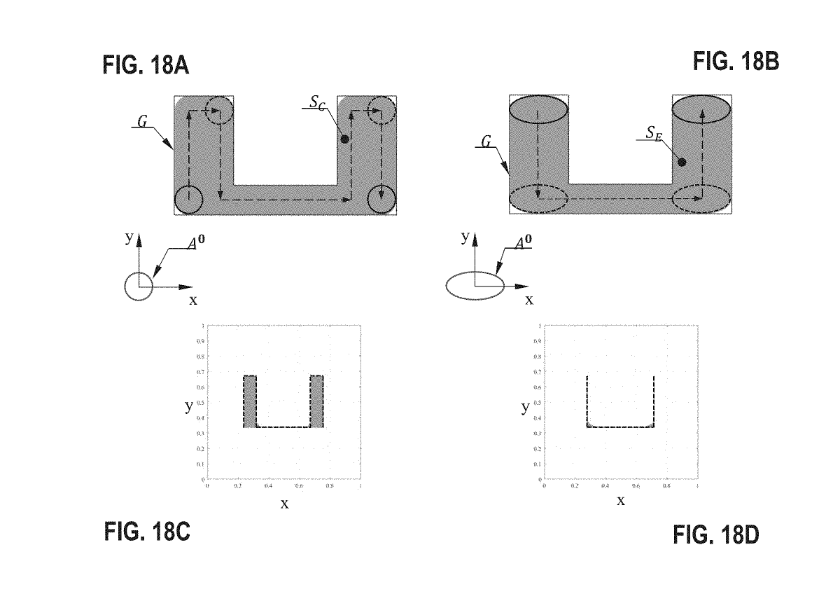

FIGS. 18A-29C accompany the following description of a computational framework for computing the maximum build volume for given non-circular extruders and printing machines that have 2, 3 and perhaps higher number of degrees of freedom (DOF). The proposed method also outputs the accessible configuration space of a multi-DOF AM machine that is instrumental in planning the final (temporal) motion of single or multiple print heads. Furthermore, the proposed method allows the ranking of multiple extruders based on their volumetric deviation from nominal geometry. This formulation makes no assumption about the number of machine DOFs, nor about the planarity of the target contour, making it applicable to emerging AM technologies such as 6-axis printing with non-planar layers, and layer-less additive manufacturing.

An issue in AM, which to this date is still not well addressed, is predicting the build accuracy and its relationship to the total build time. For example, in FDM, the accuracy of the as-manufactured geometry can be partially controlled in-process by choosing a convenient in-fill pattern or modulating the printing head speed and nozzle temperature around small area features. Though, the effects of this process optimization are ultimately limited by the kinematic configuration of the AM machine as well as by the geometry and size of the extruder. On the other hand, the latter two factors have the greatest potential for improving the build accuracy and, in particular, without negatively impacting the build time. Furthermore, more general machine kinematics offering the ability to print on non-planar surfaces, particularly in conjunction with non-circular print heads, could reduce not only the print time required by the model itself, but also decrease the amount and complexity of the required support structure with all its implications on the ultimate cost of the 3D printing.

The nozzle's shape has been traditionally yet, perhaps, unnecessarily constrained to be circular, and the printing of small features imposes an upper bound on the size of the nozzle. However, the smallest printable feature, or print resolution, is fundamentally limited by both the shape and dimensions of this extruder along with the usual material-related parameters. This resolution can be improved locally in-process by controlling the filament flow rate or under/over extrusion, although the extruder geometry remains a significant contributing factor to the build accuracy.

FIGS. 18A-D present a conceptual example of a small U-shaped feature which is desired to be printed as close to nominal geometry as possible. FIG. 18A shows a smaller circular extruder and the simplest trajectory of its center that would maintain the extruder within the given contour. It is clear that the print head executes at least seven linear interpolations to fill this contour, while the elliptical extruder of FIG. 18B can execute just three. The asymmetry of the elliptical extruder with respect to its center also allows it to navigate in the narrower regions of the contour, for example the bottom passage. Such an asymmetry can prove to be very useful in the case of printing machines which have rotational kinematic axes, such as Selective Compliance Assembly Robot Arms (SCARA), Delta, and Hexa architectures. In the case of Hexa machines or other 6-axis configurations, a non-circular extruder can exploit more efficiently the motion of the print head, resulting in an improved precision and a faster build time. For this simple case, it is evident that the elliptical choice provides numerous advantages, but for more complex outlines and non-planar layers it is unclear what might be the “optimal” shape of the extruder.

The invention provides a generic method relying on the properties of the inverted trajectory to identify the subset of the machine configurations for which a hot-end nozzle of known but arbitrary geometry is guaranteed not to exceed the 3D boundary of a given model. The formulation makes no assumptions about the planarity of the target contour (i.e., possibly a non-planar slice of a 3D boundary), nor about the machine's number of Degrees of Freedom (DOF) generically denoted here by p; hence the formulation can be effectively used in all emerging Additive Manufacturing processes, such as 6-axis FDM printing, as described above. By examining the intersection set between the nozzle geometry and the inverse trajectory of points sampled from the target volume, the total set of motion parameters is determined for which the nozzle is permanently contained within the target contour. This allows computation of the volume of the as-manufactured geometry as a sweep, defined by the nozzle's “smallest printable feature” and the restricted p-parameter motion (assuming a constant extrusion flow and constant velocity of the printing head). This, in turn, provides a ranking of given nozzle geometries in terms of their corresponding build accuracy and subsequently build time. The volumetric deviation between the built and the nominal volume can then be computed as a Lebesgue measure defined over the set difference between the two respective volumes. Given this restriction, the problem of motion synthesis, which is the problem of coupling the DOF of the machine to one independent parameter such as time, recasts in the framework as the problem of finding a space filling curve, under certain build quality requirements, such as surface roughness.

In general, the trajectory Tₓ of a point is defined as

$${T}_{x} = {U}_{s \hat{I} M} {x}^{s}$$

where s Î SE(3) are configurations of a family of rigid-body motions M, generated by arbitrary kinematic linkages, such as a robotic arm. Although the focus of FIGS. 18A-29C is on rigid motions, the formulation is generic and extends to affine transformations. A configuration s of a system, such as a robot arm, is defined by a set of p generalized coordinates (e.g., joint angles, prismatic translations, etc.), that are fundamentally independent. This allows the motion M to be parameterized by a vector space of parametersᵤ ÎR^{p}, where u=[u₁, u₂K uₚ]^{t} is a column vector containing the mechanism's generalized coordinates. Therefore each configuration s Î M is identified by at least one vector u, and denoted with s(u). A general mapping (SE(3) to E³) that considers all generalized coordinates to be independent, rather than dependent variables, is in general non-physical and referred to as multi-parametric motion. The physical motion of such a system can be obtained by coupling the generalized parameters by one single parameter, often time, which is the task of motion planning, and results in a one-parameter variety. As an example, the Euclidean workspace of a representative point of a 5-axis CNC machine is in general a 3D volume containing all possible spatial locations of that point that can be achieved by that particular machine (with uncoupled parameters). At the same time, the trajectory of the same point under a (coupled) one-parameter motion is usually a curve, which is a subset of the machine's workspace.

In other words, the trajectory of a point moving according to a p-parameter motion in E^{d} is a p-dimensional set if p £ d, or a d-dimensional entity if p>d. The multi-parameter trajectory of a point is the superset of all one-parameter trajectories that can possibly be synthesized in a time-based reference system. By applying the inverse transforms r Î SE(3) such that r(u)\check{A}s(u)=id_{d} to a sample point y Î E^{d}, where id_{d} is the d-dimensional Identity transformation, the so-called inverse trajectory of the sample point y is obtained, similarly defined as

$${\hat{T}}_{y} = {U}_{r \hat{I} \hat{M}} {y}^{r}$$

In this formulation, Å is the group additive operator, and \hat{M} is the set of inverse transformations, also known as the inverted motion; for example, if the transformations are represented as homogeneous transformation matrices, then the group operator is the usual multiplication of matrices, and the inverse transformations are given by matrix inverse. The property of the inverse trajectory states that only the points x Î \hat{T}_{y} will pass through the sample point y during the motion M, which can be readily verified from the definition of the inverse transformation r=ŝ. This property applies without restrictions to the number of motion parameters and the dimensionality of the Euclidean space where the points are embedded since it has a generic set theoretical formulation.

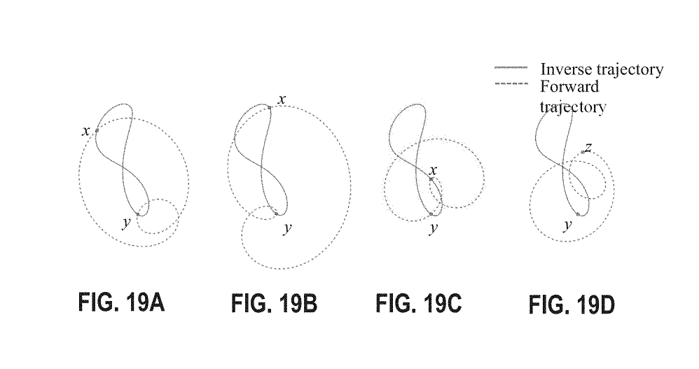

To provide a visual aid, FIGS. 19A-19D show in solid line the one-parameter inverse trajectory \hat{T}_{y} of an arbitrary point y, embedded in a two-dimensional Euclidean plane. Point y is contained in the forward trajectories of all points x Î \hat{T}_{y}, but not contained in the forward trajectory of any point z Ï \hat{T}_{y}. This property has an application in workspace analysis because it allows one to determine exact the subset X Í A of a moving set A Ì E^{d} (such as the end-effector of a robot arm) which will “visit” a workspace location y Î E^{d} during some arbitrary motion M. Namely, the subset X is determined from the set intersection X=A^{s(0)} [symbol] \hat{T}_{y}, where A^{s(0)} is the configuration of the moving set A positioned at the initial parameter values u₀ ^{o} 0=[0, 0K 0]^{t}. In the notation 0=[0,0K 0]^{t} of a normalized parametric range u Î ]0.1] is implied, although this is not a requirement of the formulation, but merely a way of denoting the initial motion configuration. Also for brevity, A^{s(0)} is denoted simply with A⁰, and is referred to as the “initial configuration” of the moving set A. Furthermore, via a set intersection, all parameter values u at which the set A sweeps the target point y can be determined. This is achieved by using a Point Membership Classification (PMC) function I:R^{p}·E^{d} ® {0,1}, defined as

$$I ( u , y ) = \begin{matrix}1 , if {A}^{0} {y}^{{r ( u )}_{1}} \\ 0 , otherwise\end{matrix}$$

This indicator function I(u,y) is used to determine a restriction on the motion parameter space R^{p} for which the opening of a 3D printing nozzle can only move inside a given geometry of arbitrary complexity.

As stated above, a goal of the present invention is to derive a computational framework to determine the maximum volume that can be built using a known extruder of arbitrary design, without exceeding the boundary of a given a nominal geometry. Ideally the built geometry should be identical to the target geometry (i.e., no over- or under-fill of the target contour). A factor that significantly limits the build accuracy is the shape and size of the print nozzle, since its resolving power degrades rapidly around small features such as sharp corners and bosses.

The maximum volumetric deviation between the as-manufactured and the nominal geometry can be formulated in terms of Maximum Material Condition (MMC) tolerance. More information about geometric tolerances such as MMC, least material condition (LMC) and the reciprocity condition can be found in ISO 2692 and ISO/TC 213. In addition, a ranking of several given extruders can be given in terms of the deviation of the corresponding as-manufactured geometries from the nominal geometry. The highest ranking extruder will have the smallest MMC tolerance, or, in other words, the largest volume of deposited material without exceeding the target boundary of the nominal geometry. The key to the formulation is to compute a restriction of the printing head's motion, represented as a set of configurations, for which the nozzle is fully contained in the target domain. All motion configurations are represented as points in a p-dimensional space where p is the number of generalized coordinates. Thus a restriction of the motion is a set P Î R^{p}. To prevent confusion, sets of the usual Euclidean space are denoted with uppercase letters (i.e. A, X, G, etc.) and sets of the parametric space with a stylized font (i.e. B,C,P, etc.).

If y Î G is a point of the target geometry G Ì E^{d}, and A⁰ Ì i E^{d} is the nozzle geometry in its initial configuration, the parameter vectors u for which the inverse trajectory \hat{T}_{y} intersects the nozzle geometry A⁰ are precisely the motion parameters at which the nozzle A passes through point y of the target G during the given (forward) motion. With the indicator function I, a set of configurations c Ì R^{p}, where C={Î R^{p}M(u,y)=1, ″y Î G} is accumulated. In other words, the parametric range C contains all motion parameter values where the nozzle can potentially deposit material over the target G. The complete set C also contains the parameters for which the extruder deposits material both inside and outside of the target geometry. This is unwanted when enforcing an MMC tolerance. These undesirable motion parameters, which are elements of a subset B Ì) R^{p} and defined by B={u Î R^{p} M(u,x)=1, ″x Î¶G}, are those parametric values for which the extruder intersects the boundary of the target geometry. The parametric set which will enforce the MMC tolerance is given by P=C, B.

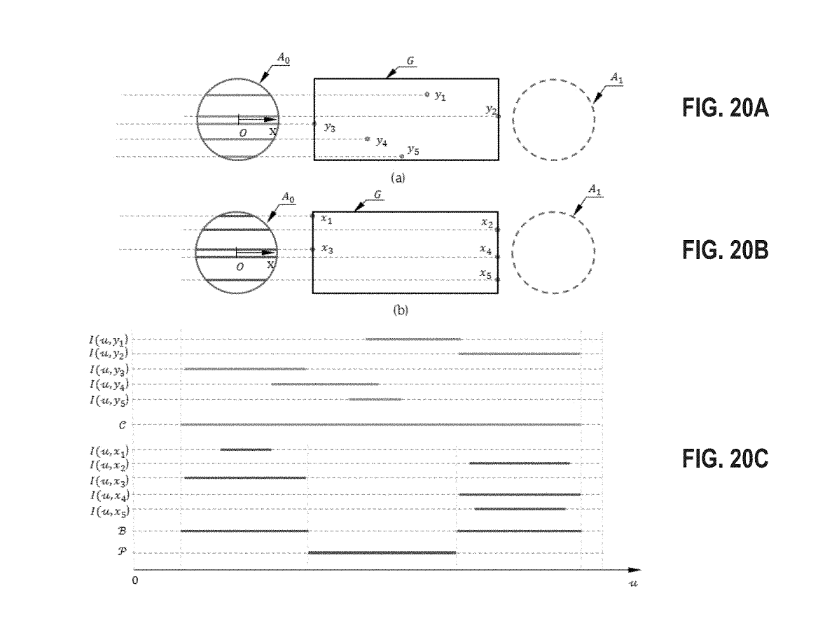

To illustrate, FIGS. 20A-C show a simplified example where the extruder A can only move on a single horizontal axis between two extreme configurations. The shape of the extruder is circular, and the nominal geometry G is a rectangle aligned with the motion direction. For illustrative purposes it is assumed that the height of the contour is identical to the diameter of the nozzle, so that the contour can be filled with a single pass along the axis of motion. By accumulating all parameter values at which the inverse trajectories of samples y, Î G intersect the nozzle in its initial configuration, all extruder configurations where material can be deposited over G are effectively determined, including those for which the nozzle extrudes both inside and outside the boundary of G. If the rapid prototyping machine extrudes within the configuration range B, the nozzle only extrudes over the boundary of the target geometry. Consequently, when the machine extrudes in the range P=C, B, the built geometry is guaranteed to be not over-extruded because set P contains only those parameter values for which the nozzle in fully contained in set G, and thus enforcing the maximum material condition.

Even though in all the examples it is assumed that process parameters (material flow, print-head speed, etc.) that determine the shape and size of the smallest printable feature remain constant during motion, this is not a limiting factor. The proposed formulation remains valid and can be applied to even more general cases involving deformations of the deposited material as long as they can be incorporated as additional variables, or non-rigid motions, in the motion parametrization.

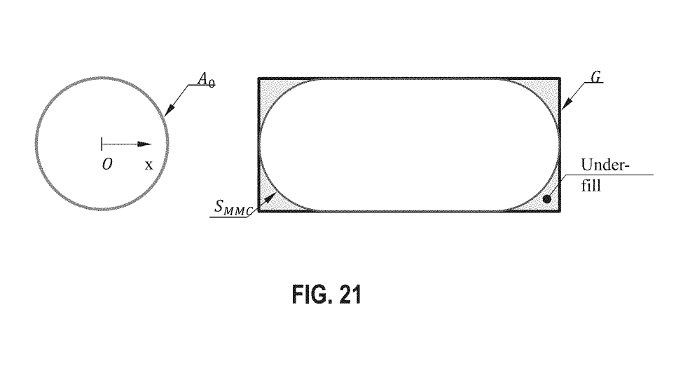

The restriction P is used to determine the as-manufactured volume (see FIG. 21) corresponding to the MMC tolerance as a solid sweep. This is determined using the usual definition of a sweep, where the transformations applied to the nozzle's geometry A are parametrized by vectors of the subset P.

$${S}_{MMC} = {U}_{u \hat{I} P} {A}^{s ( u )}$$

In this formulation, an automatic selection of nozzle geometry can also be performed based on the volumetric deviation between the as-manufactured geometry S_{MMC} relative to the nominal geometry G. More specifically, the highest ranking nozzle will correspond to the smallest Lebesgue measure of the set difference min[/(G\S_{MMC})] where i represents the i-th hot-end nozzle being compared.

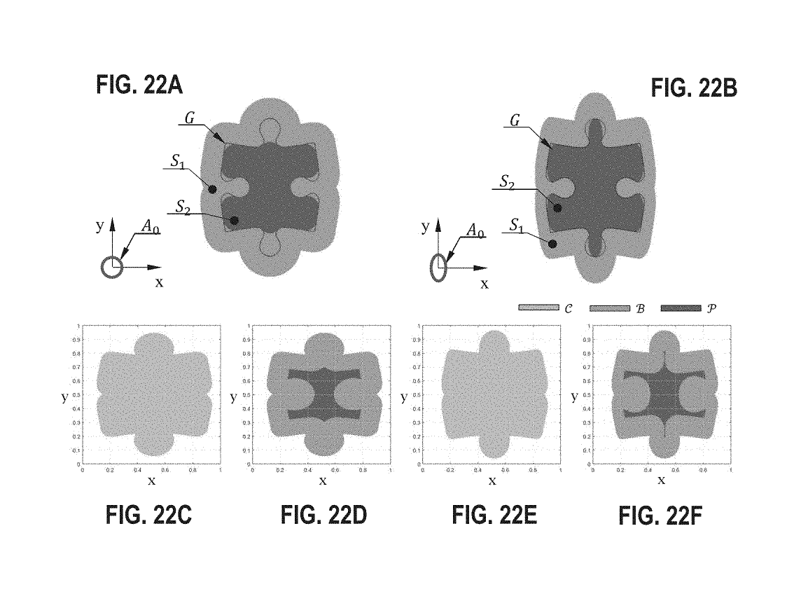

FIG. 21 shows the under-fill areas created by enforcing the MMC tolerance condition. FIGS. 22A-F and 23A-C provide simple examples using the formulation. In FIGS. 22A-F, the nozzle can translate in the XY plane. The elliptical nozzle in FIG. 22B not only has a larger built volume (s₂) than the built volume due to the circular extruder, but can also resolve the sharp corners with a higher accuracy. For illustration, the figure also shows the volume s₁ swept by the nozzle A in the parametric restriction B. The built volume in FIG. 22B is also larger because the nominal geometry is conveniently aligned with the semi-major axis of the asymmetric extruder. This shows that a Cartesian Rapid Prototyping machine cannot fully take advantage of the asymmetric shape of an extruder unless the target contour is intentionally placed along one of the principal directions of the extruder. On the other hand, a machine that allows print-head rotations can reorient the nozzle so that, regardless of geometry orientation, the extruder can be brought in a convenient orientation which provides maximum local precision.

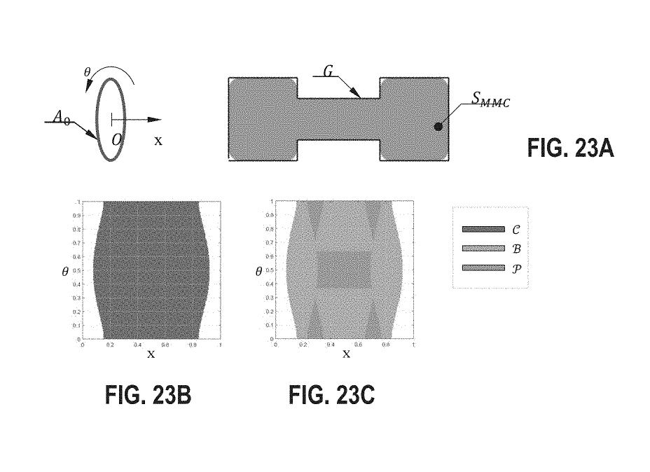

In FIGS. 23A-C, the available motions are one rotation about the nozzle's axis and one translation. In this case an asymmetric extruder can take advantage of the extra rotation and navigate through narrow passages. The set theoretic formulation implies that the method allows both translations and rotations, unlike other approaches based on mathematical morphology. A further advantage of the method is its invariance to the dimensionality of the parametric space. In principle, any arbitrary motion with as many degrees of freedom is supported. Moreover, there are no restrictions on the planarity of the build contour, thus paving the road forward for applications in multi-axis FDM printing and other emerging Additive Manufacturing processes.

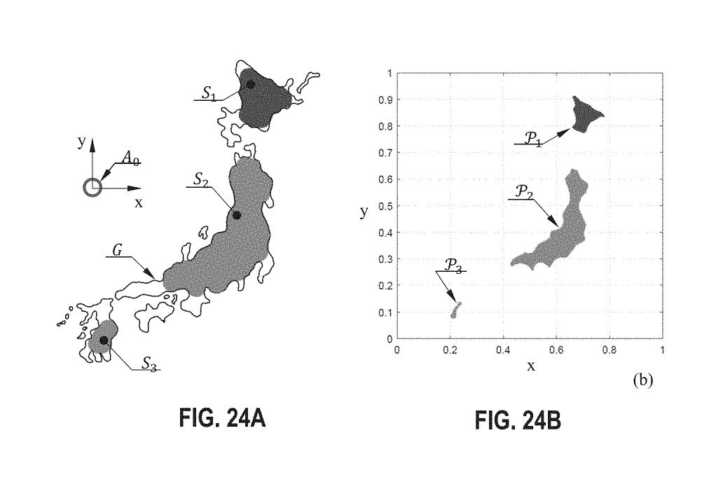

In the test case, a comparison in build accuracy is shown between two machines which have attached a circular and an elliptical extruder nozzle. FIGS. 24A-B show a circular extruder capable of a planar XY motion. The “keep-in” contour is a sketch of Japan's coastline. To emphasize the deviation between the nominal and built geometry, an extruder large in comparison to the small features of the target contour G is chosen. As expected, the build area deviates significantly from the nominal geometry, simply because the extruder is too large to extrude over the small features without over-filling. The example additionally shows that the method is completely impervious to disconnected sets. In this case, there have been identified three different sets which are printed sequentially or, depending on equipment, simultaneously using multi-extruder print heads. Here sᵢ=sweep [A,M(Pᵢ)] represents the sweep of nozzle A under the parametric selection Pᵢ, and is mathematically given by Sᵢ= [symbol] A^{s(u)}, where u Î Pᵢ.

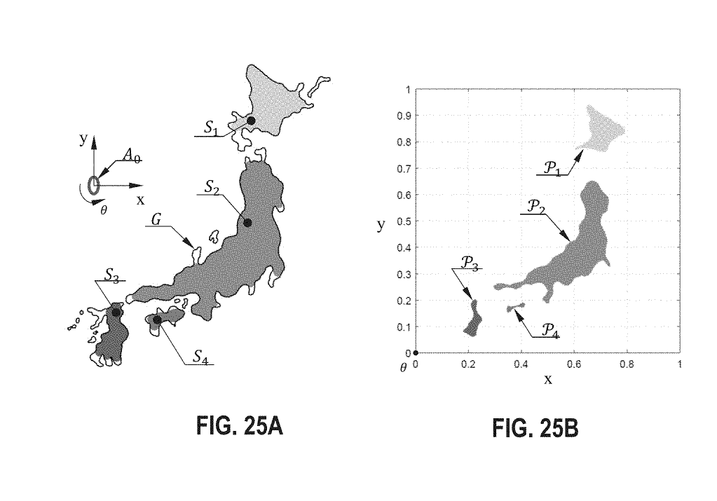

As shown in FIGS. 25A-25B, the extra degree of freedom (the rotation about the extruder's axis) permits the asymmetric extruder to cover more of the nominal geometry without exceeding the target boundary. In addition, this configuration is capable of printing a fourth region s₄ of the nominal geometry. The increase in build surface area is 17.62% as compared to the combined build areas of the circular extruder shown in FIG. 7.

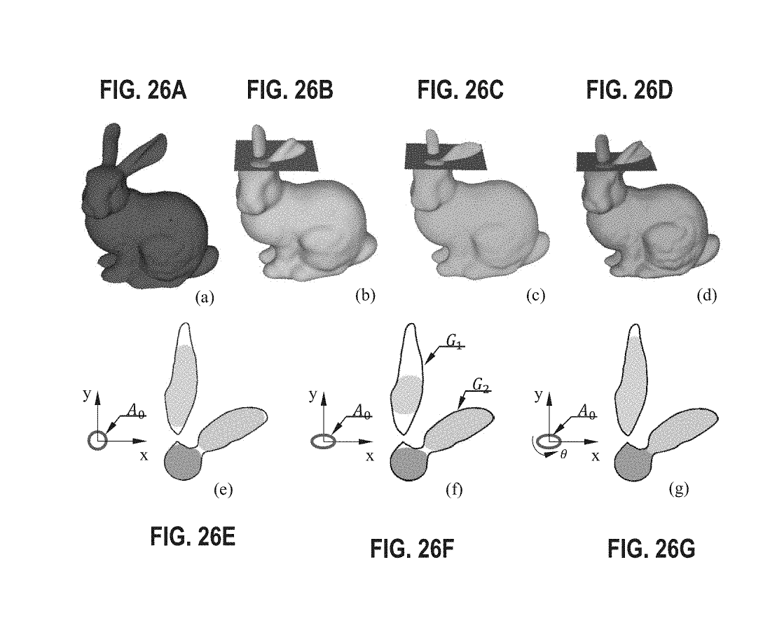

The application in FIGS. 26A-G depicts a 3D geometric model built with a circular and respectively, an elliptical extruder. In this example the nominal model from FIG. 26A is sliced in 278 layers, using commercial mesh processing software. This allows the computation to be reiterated over the total number of layers. FIG. 26B shows the built geometry using a circular extruder and a classical Cartesian machine. To emphasize the printability of small features, the model is scaled down to dimensions comparable to the nozzle size. The circular extruder in this example acts as a low-pass filter, smoothing the model texture loosing most of the small features. In FIG. 26C, the same Cartesian machine is used in combination with an elliptical extruder. Since there are no rotations, the machine cannot take advantage of the nozzle asymmetry resulting in a built model that has a “preferred” direction, aligned with the semi-major axis, where small feature are better resolved. To emphasize this effect, the nozzle is oriented so this direction is aligned with the x-axis (left to right in the image). Because of this less than optimum orientation, the built model shows a poorer resolution when compared to the one in FIG. 26B. Finally, in FIG. 26D, the model is built using the same elliptical extruder but this time on a T-T-R machine configuration. The extra rotation about the extruder's center axis allows the nozzle to cover small features in any planar direction, and thus following more closely the nominal geometry. Using this configuration, a 4.2% increase in build volume is achieved, compared to the model in FIG. 26C.

FIGS. 26E-G show a section of the computed volumetric builds. In FIG. 26E, corresponding to the model in FIG. 26B, the extruder used is circular and is capable of translating in the XY plane. Small features of the layer contour (shown in black) cannot be printed because the size of the extruder is too large. FIG. 26F corresponds to the model shown in FIG. 26C and shows the use of an elliptical extruder in planar translation. The asymmetry of the extruder and the lack of rotation favor the x-axis in terms of precision. In this machine setup, a printable feature G₂ that is aligned with the x-axis can be printed with much higher accuracy than the feature G₁, which is aligned with the y-axis. Lastly, in FIG. 26G the elliptical extruder has an extra rotation about its center axis. This ensures that the minor radius of the nozzle can be used in any orientation and thus resolving smaller features, regardless of their orientation with respect to the build volume. Out of the three machine configurations under study, the model in FIG. 26D has the largest build volume, without exceeding the boundary of the nominal geometry, thus the best MMC tolerance.

The GPU accelerated algorithm is a straight-forward implementation of the method described above, and uses point clouds and homogeneous transformation matrices to carry out the computation. The machine used to run this software is a Dell Precision 7910 with dual Xeon processor clocked at 2×2.3GHz, an nVidia Quadro K2200 graphics card and 64 GB of RAM. Using this configuration, an average execution time of approximately 37 s is achieved for each of the models in FIG. 9.

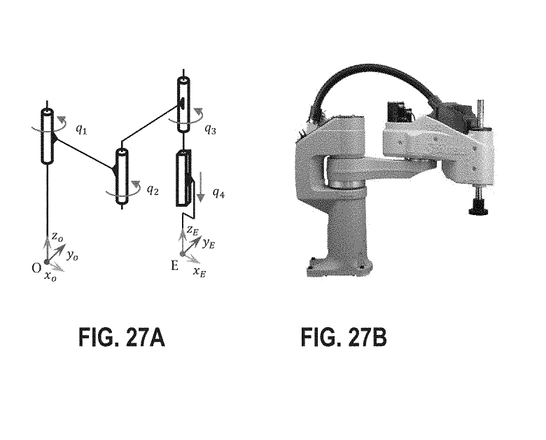

In this example it is shown how this method can be applied to “layer-less” 3D printing of shapes as a cost-effective and accurate alternative to 3D build volumes, printed with Selective Laser Sintering (SLS). In this example the printing is achieved using a 4-DOF Selective Compliance Assembly Robot Arm (SCARA), shown in FIGS. 27A-B. The mechanical structure of this robot has 4 DOF that include a displacement of the nozzle along the z-axis, as well as three rotations about the local z-axes. Importantly, the method can be applied to printing with devices that have multiple degrees of freedom and print on planar as well as non-planar surfaces.

The abovementioned systems and methods can be applied for medical uses. The medical destination of these builds requires the deposited material to be USP-NF class VI compliant and meet the ISO-10993 standard for biocompatible thermoplastics. In this application, FDM is utilized without the need of depositing the material in a classic layer-by-layer approach. In the formulation, the motion of the printing head is not restricted to a plane. Therefore the as-manufactured geometry can be computed without a pre-set build direction or constant thickness layers. As described above, all print-head configurations for which the extruder nozzle is contained within the 3D boundary of the nominal geometry are identified, and the as-manufactured geometry is computed as a sweep defined by the extruder's smallest printable feature transformed by a restricted set of configurations. Once this information is available, one can explore the motion planning aspects of this “layer-less” 3D printing.

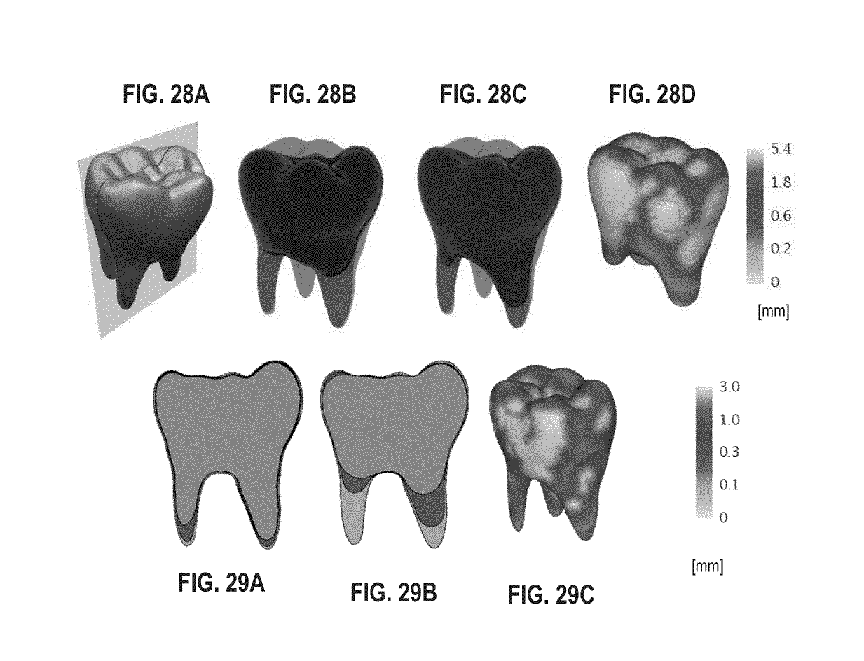

The nominal geometry in this example is an average-sized maxillary first molar of an adult. To emphasize the difference in built volume, the as-manufactured geometry is presented using oversized extruders with a circular, and respectively an elliptical opening. FIG. 28(a) shows the nominal geometry of the molar as well as the position of the section plane used in the corresponding section views. FIGS. 28(b) and (c) show how the oversized extruders cannot resolve the small features corresponding to the roots of the molar. In FIG. 28(d), the thickness of the additional volume of material deposited by the elliptical extruder compared to the circular one is color coded. The figure shows that only the low curvature sections of the model can be printed with the same accuracy by the two extruders.

FIGS. 28A-D and FIGS. 29A-C illustrate a more realistic 3D build of a first molar. The circular extruder of f 1.28 mm, which is regarded as a relatively large nozzle, does not adequately print the roots of the molar, making it unsuitable for this application. On the other hand an elliptical extruder of the same semi-major axis but a semi-minor axis of a=0.71 mm achieves a higher geometric accuracy, while maintaining the benefits of using a relatively large nozzle, including decreased printing time and increased durability. Even though the difference between the as-built and nominal volumes shown here is below 5%, the method that is presented here can identify the small features of the nominal model that cannot be printed with given nozzle geometries and machine kinematics. For a side-by-side comparison, FIG. 28B shows a cross-section of the as-manufactured models using the course extruders.

A generic method is presented for computing the as-manufactured geometry in additive manufacturing, which, in turn, provides a ranking of given nozzle geometries in terms of their corresponding build accuracy and subsequently build time. This method is applicable to printing on planar and non-planar surfaces, with extruders of arbitrary geometry and with machine kinematics that have multiple degrees of freedom, including rotations. The Maximum Material Condition is enforced as a dimensional tolerance to have a meaningful comparison of build volumes. In effect, this tolerance acts as a maximizer of the built volume while ensuring that the nominal boundary is not exceeded. The effectiveness of this method is exemplified with an elliptical extruder as an alternative to nozzles with a circular opening, although the generic method accepts any arbitrary geometry.

The formulation is derived in set theoretical terms and uses the concept of the inverse trajectory, which allows it to be implemented in virtually any geometric representation which supports distance computations. Time is not considered in the derivations; instead the motion is treated as a set of configurations parametrized by the mechanism's generalized coordinates. The ability to calculate the motion restriction which will prevent the nozzle from exceeding the nominal boundary can be viewed as a precursor to motion synthesis. Any one-parameter coupling of all generalized coordinated is represented in this parametric space as a curve. Therefore, a re-parametrization of this motion under time (i.e., motion planning) recasts itself as a space spanning curve in a p-dimensional space, given certain quality requirements. This formulation does not enforce the planarity of the build layer, which makes the approach suitable for layer-less AM technologies such as 6-axis Fusion Deposition Modeling and laser jet cladding.

The mathematical framework presented here provides all the information necessary for a subsequent as-manufactured geometry optimization. By relaxing locally the MMC condition, the build accuracy can be further improved locally by over-extrusion. Such an analysis can be carried in the parameter domain, for example by mapping the over-extruded geometry as a signed distance function from the boundary. Such an approach would identify and correct boundary regions where the built accuracy exceeds a target value.

Various features and advantages of the invention are set forth in the following claims.

What is claimed is:

1. A method of depositing a material with an extrusion tip of an additive manufacturing machine, the method comprising:
translating the extrusion tip relative to a build platform; and
rotating the extrusion tip about an axis of the extrusion tip relative to the build platform.

2. The method of claim 1, further comprising expelling a material while translating and rotating the extrusion tip.

3. The method of claim 2, wherein the extrusion tip has a non-circular aperture, wherein the material is expelled from the extrusion tip via the non-circular aperture.

4. The method of claim 1, wherein the extrusion tip is simultaneously rotated and translated.

5. The method of claim 1, wherein the extrusion tip includes a semi-major axis of a first width and a semi-minor axis of a second width less than the first width, wherein rotating the extrusion tip modifies the width of the extruded material in the translated direction.

6. The method of claim 1, wherein the extrusion tip has an elliptical geometry configured to expel a material in an elliptical shape.

7. The method of claim 1, wherein the build platform defines an XY plane onto which a material is printed, wherein the extrusion tip is operable to translate in an X-direction, a Y-direction, and a Z-direction normal to the X-direction and the Y-direction.

8. The method of claim 1, wherein the build platform defines a non-planar surface onto which material is printed.

9. The method of claim 1, further comprising tilting the extrusion tip relative to the build platform or tilting the build platform relative to the extrusion tip.

10. The method of claim 1, further comprising directing the extrusion tip in a normal direction to a three-dimensional curve within a build volume of the additive manufacturing machine.

11. An additive manufacturing machine comprising:
a build platform; and
an extrusion tip having an aperture through which a material is operably expelled to the build platform, the aperture defining an axis,
wherein the extrusion tip is configured to translate relative to the build platform, and
wherein the extrusion tip is configured to rotate relative to the build platform about the axis.

12. The additive manufacturing machine of claim 11, wherein the extrusion tip has a non-circular aperture, wherein the material is operably expelled from the extrusion tip via the non-circular aperture.

13. The additive manufacturing machine of claim 11, wherein the extrusion tip is configured to simultaneously rotate and translate.

14. The additive manufacturing machine of claim 11, wherein the extrusion tip includes a semi-major axis of a first width and a semi-minor axis of a second width less than the first width, wherein rotating the extrusion tip modifies the width of the extruded material in the translated direction.

15. The additive manufacturing machine of claim 11, wherein the extrusion tip has an elliptical geometry configured to expel a material in an elliptical shape.

16. The additive manufacturing machine of claim 11, wherein the build platform defines an XY plane onto which a material is printed, wherein the extrusion tip is operable to translate in an X-direction, a Y-direction, and a Z-direction normal to the X-direction and the Y-direction.

17. The additive manufacturing machine of claim 11, wherein the build platform defines a non-planar surface onto which material is printed.

18. The additive manufacturing machine of claim 11, wherein the extrusion tip is configured to tilt relative to the build platform and/or the build platform is configured to tilt relative to the extrusion tip.

19. The additive manufacturing machine of claim 11, further comprising a support arm mounted to the extrusion tip and configured to direct the extrusion tip in a normal direction to a three-dimensional curve within a build volume defined by the build platform.

20. A method of preparing motion synthesis for a target geometry with a 3D printer having an extruder, the method comprising:
determining a set of configurations parametrized by a vector of length P, wherein P is the number of degrees of freedom of the 3D printer;
determining a plurality of machine parameters for which the nozzle geometry is contained in the interior of a target geometry G;
calculating a parametric set [symbol] and a parametric set [symbol] corresponding to a plurality of extruder configurations in which the extruder is touching the point p and is interior to the target geometry G;
calculating a normal, tangent, and binormal direction and the radial distance r corresponding to the point p; and
calculating the angles between all candidate semi-major axes and the local normal direction at the point p.
